(19) United States
(12) Patent Application Publication
(10) Pub. No.: US 2009/0190579 A1
(43) Pub. Date: Jul. 30, 2009

(54) Service routing decision entity

(76) Inventors: Andreas Witzel, Herzogenrath (DE); Ralf Keller, Würselen (DE)

Correspondence Address: ERICSSON INC., 6300 LEGACY DRIVE, M/S EVR 1-C-11, PLANO, TX, 75024, US

(21) Appl. No.: 11/912,798

(22) PCT Filed: Apr. 27, 2005
(86) PCT No.: PCT/EP2005/004515

§ 371 Date: Jun. 23, 2008

(51) Int. Cl. H04L 12/66

(52) U.S. Cl. 370/353

(57) ABSTRACT

A service routing decision entity and method are described for a system that comprises a circuit switched subsystem, an Internet protocol multimedia system subsystem and at least one mobile terminal suitable for communication with the two subsystems. The two subsystems provide overlapping services. The service routing decision entity and method are arranged to make a routing decision associated with a given service involving the mobile terminal with respect to routing the given service via one or both of the circuit switched subsystem and the Internet protocol multimedia system subsystem, based on predetermined decision information.

### FIELD OF THE INVENTION

The present application relates to a service routing decision entity and a service routing decision method for a system that comprises a circuit switched subsystem, an Internet Protocol Multimedia System (IMS) subsystem and at least one mobile terminal suitable for communication with the circuit switched subsystem and the IMS subsystem.

### BACKGROUND OF THE INVENTION

In the field of mobile communication, circuit switched networks have traditionally been used, as e.g. in the GSM system. GSM has been steadily updated, and also more recently developed mobile communication systems such as WCDMA and CDMA (in accordance with the third generation partnership project 3GPP) are also based on circuit switching.

Furthermore, communication systems are presently being developed and used that are based upon the Internet Protocol (IP), namely the so-called IP Multimedia System (IMS). IMS is also standardised under the third generation partnership project. IMS based networks are being used to provide a plurality of services to the user of a mobile terminal, such as simple messaging or presence services, but more increasingly also telephony services such as Voice-over-IP (VoIP). As an example, it is presently already possible to provide an IMS based telephony service using WLAN radio access technology.

This leads to a number of problems for the providing of services to a mobile terminal that is capable of interacting with a circuit switched subsystem of an overall communication system, and with an IMS subsystem of such an overall communication system, if the circuit switched subsystem and the IMS subsystem have an at least partially overlapping sets of services to offer. This will be explained in more detail with respect to an example, in which it is envisioned to have a circuit switched subsystem and an IMS subsystem that both provide a voice call service. In other words, the voice call service is an overlapping service between the two subsystems. In the event that the mobile terminal is located such that it can only communicate with one of the subsystems, the providing of a voice call service for originating calls is straight forward, i.e. the user must use the subsystem that is available. On the other hand, for terminating calls problems can occur. For example, when moving, the mobile terminal can lose radio coverage for one or both of the two subsystems, possibly without having had time to appropriately update the networks. In this case requests for terminating calls to the mobile terminal will still try to reach the subscriber through one subsystem, although he may have moved and is actually reachable via the other subsystem.

If the mobile terminal is located such that it can receive service from both the circuit switched subsystem and the IMS subsystem, there is the problem that the user or control nodes in the respective subsystems will not be able to efficiently route the desired service.

### OBJECT OF THE PRESENT INVENTION

The object of the present invention is to provide a solution to the above-mentioned problems that occur with respect to a circuit switched subsystem and an IMS subsystem that provide overlapping services.

### SUMMARY OF THE INVENTION

The above object is solved by the subject-matter of the independent claims of the present application. Advantageous embodiments are described in the dependent claims.

In accordance with the present invention, a service routing decision entity is provided, which is arranged for making a routing decision associated with a given service (e.g. a voice call) involving a mobile terminal (e.g. an originating or a terminating call) with respect to routing the given service via one or both of the circuit switched subsystem and the IMS subsystem, based on predetermined decision information.

A service within the meaning of the present specification and claims is any functionality of a subsystem offered to a user of said subsystem. This definition of service corresponds to that given in 3GPP TR 21.905. Examples of services are the placing of a call (e.g. a voice call, a video call, etc.) or the communication of a message (a text message, a voice message, a video message, etc.).

An entity within the meaning of the present specification and claims is any arrangement suitable for providing a given function, where the entity can be a unit located in one node or terminal of a network, or it can be a system spread out over different nodes and terminals. The entity can be embodied as hardware, software or any suitable combination of hardware and software.

The decision information used by the service routing decision entity can be chosen in any suitable or desirable way. It can e.g. be a reachability information associated with the reachability of the mobile terminal and/or a preference information associated with a preference set by an operator or a user, a subscription information, a time information associated with a time of day, a load information relating to the load of a subsystem, a coverage information associated with the coverage of a subsystem, an availability information, a service type information, a service use information, a connection information associated with active connections, and a capability information associated with the capability of the mobile terminal or one or more nodes of the subsystems.

Due to the service routing decision entity, the previously described problems of the prior art are solved. Namely, the service routing decision entity is capable of automatically deciding how to route a given service, whereby an efficient and desired use of the subsystems can be obtained.

### BRIEF DESCRIPTION OF FIGURES

The present invention will now be described in more detail based on specific embodiments and with reference to the enclosed figures where

FIG. 1 gives a schematic overview of an embodiment of the present invention;

FIG. 2 gives a schematic overview of a circuit switched subsystem and an IMS subsystem in which the present invention can be embodied in a number of ways;

FIG. 3 shows a flow chart of a basic method embodiment of the present invention;

FIG. 4 shows a flow chart of another method embodiment of the present invention;

FIG. 5 shows a flow chart of a further method embodiment of the present invention; and

FIG. 6 shows yet another flow chart of a method embodiment of the present invention.

### DETAILED DESCRIPTION OF EMBODIMENTS

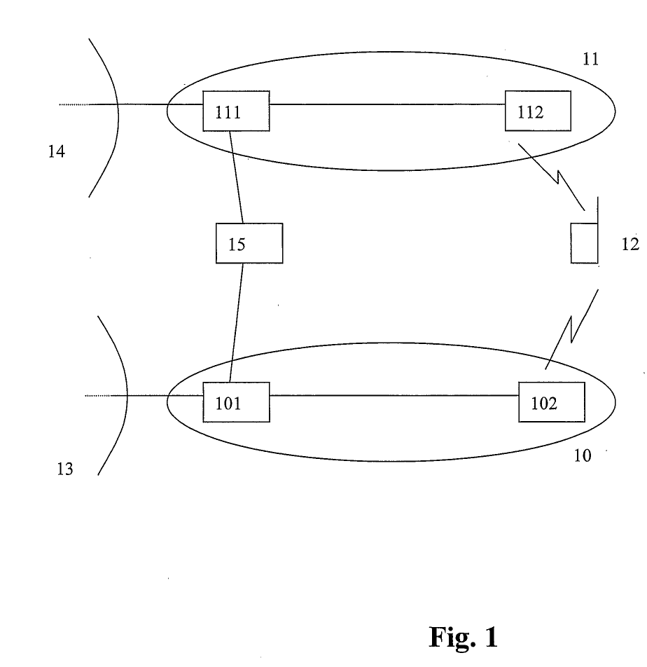

FIG. 1 shows a schematic representation of an embodiment of the present invention. Reference numeral 10 refers to an Internet Protocol Multimedia system (IMS) subsystem, and reference numeral 11 describes a circuit switched subsystem. A mobile terminal 12 is suitable for communication with the circuit switched subsystem 11 and the IMS subsystem 10.

Reference numerals 13 and 14 relate to further communication networks or subsystems with which the subsystems 10 and 11 can interact. Networks 13 and 14 could e.g. be a public switched telephone network (PSTN), a computer network such as the Internet, etc. The connections shown in FIG. 1 are only an example, and the subsystems 10 and 11 could both be connected to each of the networks 13 and 14, and it is also possible that there are more or less further networks than the shown networks 13 and 14.

In FIG. 1 reference numeral 101 relates to a control node in the IMS subsystem, said control node being suitable for controlling the provision of a service to the mobile terminal 12. Reference numeral 102 describes an access node via which the mobile terminal 12 accesses the IMS subsystem 10.

Reference numeral 111 similarly relates to a control node of the circuit switched subsystem 11, suitable for controlling and managing service provision of the circuit switched subsystem 11 to the mobile terminal 12. Reference numeral 112 describes an access node via which the mobile terminal 12 can access the circuit switched subsystem 11.

It is noted that the representation in FIG. 1 is only schematic, and that the subsystems will generally comprise a larger number of nodes, e.g. intermediate nodes and gateway nodes, which are not shown for simplicity. Furthermore, it is possible that specific access networks are arranged between the mobile terminal 12 and the subsystems 10 and 11. The figure shows one mobile station 12 for the purpose of simplicity and clarity, but it should be understood that an actual communication system will be arranged to provide service to a much larger number of mobile stations.

The circuit switched subsystem 11 and the IMS subsystem 10 are such that the circuit switched subsystem provides a first set of services and the IMS subsystem provides a second set of services. The first and second set of services are at least partially overlapping, which in other word means that the two subsystems 10 and 11 offer at least some of the same services to the mobile terminal 12. For example, it is possible that both subsystems provide the service of establishing voice calls, where e.g. the circuit switched subsystem could do this based on the GSM standard, whereas the IMS subsystem could do this based on the principles of Voice-over-IP. Naturally, the two subsystems could also have other or more services in common. Other services could be video calls or video streaming (point-to-point, point-to-multipoint or broadcasting), messaging (text, voice or video), etc.

In accordance with the present invention, a service routing decision entity 15 is provided. The service routing decision entity is arranged for making a routing decision associated with a given service involving the mobile terminal 12 with respect to routing the given service via one or both of the circuit switched subsystem 11 and the Internet Protocol Multimedia System subsystem 10, based on predetermined decision information.

As a consequence, when a situation occurs in which a service is to be routed to the terminal 12, e.g. after having received a request for such a service, such as a terminating or originating call request, the service routing decision entity 15 considers predetermined decision information, e.g. relating to the reachability of the mobile terminal 12, the capabilities of the subsystems, etc., in order to then make a decision through which of the subsystems to route the service and to send a corresponding decision signal to the subsystems. It is noted that the present invention also envisions the possibility of routing one service through both subsystems, if this is desirable and/or feasible. For example, if both subsystems are capable of video streaming, and the mobile terminal is reachable via both subsystems, there can be situations in which it is preferred to provide the video stream via both subsystems, in order to achieve maximum reliability.

Due to the service routing decision entity, the previously described problems of the prior art are solved. Namely, the service routing decision entity is capable of automatically deciding how to route a given service, whereby an efficient and desired use of the subsystems can be obtained.

The decision information used by the service routing decision entity can be chosen in any suitable or desirable way. For example, it can be reachability information associated with a reachability of the mobile terminal 12 via one or both of the circuit switched subsystem 11 and the IMS subsystem 10. The reachability information can e.g. simply be an indication that the mobile terminal is within the range of a subsystem and capable of communicating, e.g. in an idle waiting state. Such information can be kept within the respective subsystem, e.g. in a register of connected terminals, or can be maintained in a dedicated database of the service routing decision entity.

The decision information can also be a preference information, associated with a preference set by a user of the mobile terminal, and/or set by an operator of the circuit switched subsystem, and/or set by an operator of the IMS subsystem. Such preference information can e.g. be an indication that voice calls should preferably be routed through the circuit switched subsystem, whereas video calls should preferably be routed through the IMS subsystem.

The decision information can also be a subscription information associated with a subscription of the user of the mobile terminal 12. Such subscription information could e.g. indicate a first and second type of subscription, where each subscription type correlates to certain service routing preferences. For example, the subscriber of a premium service preferably receives all services that can be routed through the IMS subsystem via said IMS subsystem, as opposed to e.g. a standard subscription for which the user preferably always receives voice calls over the circuit switched subsystem.

The decision information can also be a time information associated with a time of day. For example, the service routing decision entity can be arranged such that if a service request arrives at a certain time of day, then a certain type of service is preferably routed via a first subsystem, and preferably via the other subsystem during some other time of day. For example, during a time in which on average the circuit switched subsystem is not used to full capacity (e.g. in the early morning), then specific types of services (e.g. voice calls) are preferably routed through the circuit switched subsystem, whereas at other times of day (e.g. in the evening) at which the circuit switched subsystem is typically used to full capacity, then certain types of service (e.g. voice calls) are preferably routed through the IMS subsystem.

The predetermined decision information can also be a load information associated with a load of one or both of the circuit switched subsystem and the IMS subsystem. For example, if the load in one subsystem exceeds a predetermined threshold, then it can be decided to route such services that the other subsystem can carry over said other subsystem.

The decision information can also be a coverage information associated with a coverage of one or both of the circuit switched subsystem and the IMS subsystem. For example, if the location of the terminal is known, then the service routing decision entity can take coverage information that relates to the coverage area of the respective subsystems into account, in order to decide through which subsystem the service can be routed.

The decision information can also be availability information associated with an availability of one or both of the circuit switched subsystem and the IMS subsystem. For example, if one of the subsystems is not available, then the service routing decision entity can decide to route a requested service through the other subsystem.

The decision information can furthermore comprise a service type information associated with a service type of the given service involving the at least one mobile terminal. An example was already given above in connection with the decision information comprising preference information, namely that e.g. voice calls should preferably be routed through the circuit switched subsystem, whereas video calls should preferably be routed through the IMS subsystem. In this connection it may be noted that the preceding and the following examples of decision information can be combined in any suitable or desirable way for performing the routing decision in the service routing decision entity.

The decision information can also comprise service use information associated with one or more services actively being provided to the at least one mobile terminal. For example, if a particular service (e.g. a voice call) is being provided over the circuit switched subsystem, then the service routing decision entity can decide to route a further, different service (e.g. a video call) over the IMS subsystem.

The decision information can also comprise a connection information associated with one or more active connections involving the subsystems and the mobile terminal. For example, if a connection over the IMS subsystem to the mobile terminal is active, then the service routing decision entity can decide to route a particular service (e.g. a voice call) over the same active connection in the IMS, if the connection provides enough spare bandwidth, even if the desired service is requested for the circuit switched subsystem.

The predetermined decision information can also comprise capability information associated with a capability of the mobile terminal, or associated with a capability of a node of the circuit switched subsystem, or associated with a capability of a node of the IMS subsystem. For example, if the mobile terminal has no capabilities for receiving video data over the circuit switched subsystem, but is capable of receiving such data over the IMS subsystem, then the service routing decision entity can decide to route all video calls via the IMS subsystem, if possible, e.g. if the IMS subsystem is available and the mobile terminal is within coverage range of the IMS subsystem.

As should be understood from the above examples, the concept of service routing is distinct from the idea of packet routing. Packet routing occurs at the network layer L3, whereas service routing is arranged above L3. Service routing is not directed towards the routing of individual packets over routers in a network. Much rather, service routing relates to the choice of a subsystem from among the circuit switched subsystem and the IMS subsystem for a given service. Expressed in terms of layering, the service routing decision entity preferably operates between L7 (application layer) and L4 (transport layer).

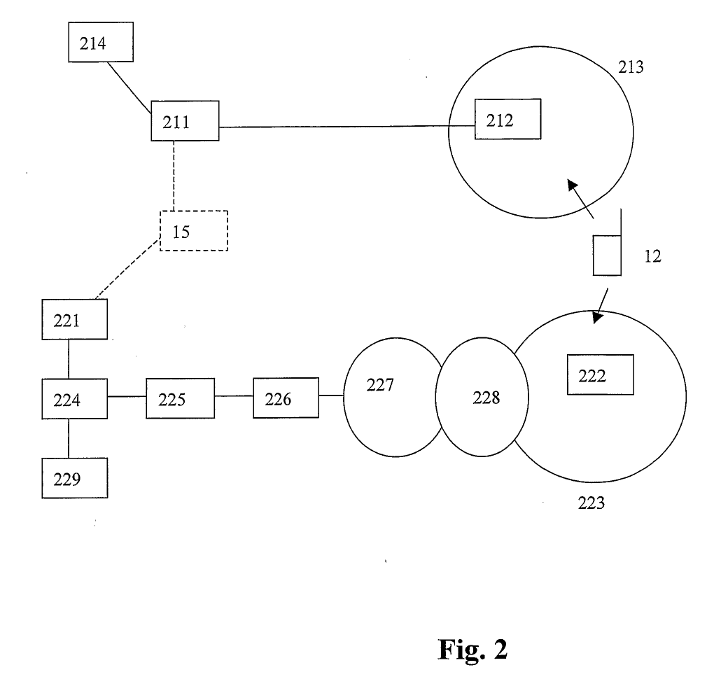

In the example of FIG. 1 the service routing decision entity 15 is shown as a unit separate from the IMS control node 101 and the circuit switched control node 111. However, the service routing decision entity can also be spread out over several nodes in and outside of the circuit switched subsystem and the IMS subsystem. This will be explained in more detail with reference to various examples that are based upon FIG. 2.

FIG. 2 shows a circuit switched subsystem and an IMS subsystem in more detail. Reference numeral 211 describes a mobile switching centre (MSC), reference numeral 214 a home location register/visitor location register (HLR/VLR) and reference numeral 212 describes a radio network controller (RNC). Elements 211, 212 and 214 are all part of a circuit switched subsystem. Reference numeral 213 is a coverage area of the circuit switched subsystem, e.g. a WCDMA coverage area.

Reference numeral 221 describes a telephony application server (TAS), reference numeral 224 a serving call/session control function (S-CSCF), reference numeral 225 describes an interrogating call/session control function (I-CSCF), and reference numeral 226 describes a proxy call/session control function (P-CSCF). Reference numeral 229 describes a home subscriber server (HSS). These elements are part of an IMS subsystem. Furthermore, the P-CSCF 226 is connected to a packet switched access network 227, which in turn is connected to a wireless local area network (WLAN) 228. Reference numeral 223 symbolizes the WLAN coverage area, and reference numeral 222 refers to a WLAN serving node (WSN).

As all of the above-described elements of FIG. 2 are well known in the art, a further description is not necessary.

In FIG. 2, a service routing decision entity 15 similar to the one shown in FIG. 1 is indicated in dotted lines. In other words, the service routing decision entity is a unit separate from the control elements 211 and 221. Although this is a possibility of arranging the service routing decision entity, the invention is by no means restricted thereto.

For example, the service routing decision entity can also be arranged in such a way that it comprises a first part in the circuit switched subsystem and a second part in the IMS subsystem. The first and the second part can be arranged in a variety of ways, e.g. the first part can be arranged for sending reachability information associated with a reachability of the mobile terminal 12 in the circuit switched subsystem to the second part, and the second part can be arranged for making a routing decision. As an example, if the terminal 12 moves into the coverage area 213 of the circuit switched subsystem, it can perform a location update in the course of which information on the mobile terminals location area is sent to the MSC 211. In accordance with an embodiment of the invention, the MSC 211 comprises the first part of the service routing decision entity and then sends an information signal to the TAS 221, which comprises the second part of the service routing decision entity. The information signal informs the TAS that the subscriber of the mobile terminal is now reachable via the circuit switched subsystem. The second part of the service routing decision entity in the TAS can then make a decision to route certain kinds of services that can be carried over the circuit switched subsystem via said circuit switched subsystem.

As an alternative or in addition to the just described concept, the second part can also be arranged for sending reachability information associated with a reachability of the mobile terminal in the IMS subsystem to the first part, and the first part can be arranged for making a routing decision. Namely, if the mobile terminal 12 moves into the coverage area 223 of the IMS subsystem, it can register or re-register with the TAS 221. The TAS can then inform the MSC 211 that the subscriber of the mobile terminal is reachable via the IMS subsystem. For the MSC 211 this means that it can make decisions to route services that the IMS subsystem can carry through the IMS subsystem.

If a service routing decision entity 15 is provided separately, as indicated in dotted lines in FIG. 2, the decision entity can e.g. be contained in a dedicated application server, where this dedicated application server may itself be separate from the two subsystems, or can be a part of one of the subsystems.

The service routing decision entity can also be completely contained in one of the two subsystems, e.g. in the routing control node 111 (FIG. 1) or MSC 211 (FIG. 2), or it can be contained in the IMS subsystem, e.g. in the routing control node 101 (FIG. 1) or TAS 221 (FIG. 2). Naturally, in a case where the routing control nodes 101 and 111 of the two subsystems are provided together in a single node, then the service routing decision entity of the present invention can also be contained in said same single node.

As a further possibility the service routing decision entity can also entirely or partially be contained in the mobile terminal 12. Examples of this will be described further on.

When using a service routing decision entity of the present invention, a plurality of advantages can be achieved in a system that comprises a circuit switched subsystem and an IMS subsystem. For example:
if the subscriber of the mobile terminal 12 has circuit switched coverage and performs a location update towards the circuit switched subsystem, the circuit switched subsystem can contact the service routing decision entity and report that the subscriber is now reachable via the circuit switched domain. The service routing decision entity can then use this reachability information for a service routing decision.
if the subscriber detaches from the HLR/VLR 214 or the subscriber is automatically purged due to a timeout or operation and maintenance interaction, the circuit switched subsystem can inform the service routing decision entity that the subscriber is no longer reachable via the circuit switched subsystem. The service routing decision entity can then use this reachability information for performing a corresponding routing decision.
if the subscriber of the mobile terminal 12 has left the service area of the current MSC 211 and a cancel location request is received from the HLR/VLR 214, then the circuit switched subsystem can inform the service decision entity that another MSC has to be used.
if the subscriber of the mobile terminal has IMS coverage and performs a registration to the TAS 221, the IMS subsystem can inform the service routing decision entity that the subscriber is now reachable via the IMS subsystem. The service routing decision entity can then use this reachability information for performing a corresponding routing decision.
If the subscriber of the mobile terminal 12 de-registers from the TAS 221, or the registration expires, the IMS subsystem can inform the service routing decision entity that the subscriber is no longer reachable via the IMS subsystem. Again, the service routing decision entity can make appropriate use of this reachability information when performing a service routing decision.

In the following, further examples of the action of the service routing decision entity will be described. As a first example, when a terminating IMS call (e.g. a voice call or a video call) is received in the IMS subsystem, the IMS subsystem can query the service routing decision entity for a decision. If only IMS subsystem coverage is currently available, the call is decided to be routed via the IMS subsystem. If only circuit switched subsystem coverage is currently available, the call is decided to be forwarded from the IMS subsystem to the circuit switched subsystem, and the call is delivered via the circuit switched subsystem. If both subsystems are available the service routing decision entity makes a decision through which subsystem to route the call.

When a terminating circuit switched call (e.g. a voice call) is received in the circuit switched subsystem, the circuit switched subsystem queries the service routing decision entity for a decision. If only circuit switched subsystem coverage is currently available, the call is decided to be routed via the circuit switched subsystem. If only IMS coverage is currently available, the call is decided to be forwarded from the circuit switched towards the IMS subsystem, and the call is routed via the IMS subsystem. If both subsystems are available, the service routing decision entity makes a decision which subsystem to use for the call.

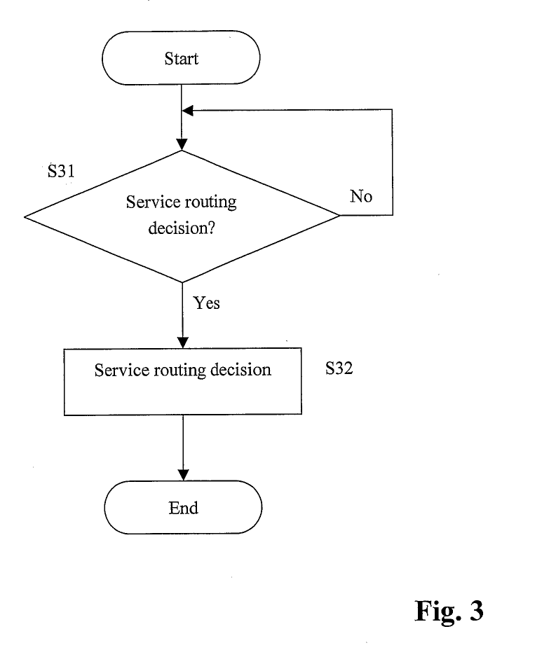

A basic service routing decision method of the invention is shown in the flowchart of FIG. 3. In a first step S31 it is established whether a service routing decision is to be made or not, and if a service routing decision is to be made, this is accomplished in step S32′. The service routing decision in step S32 is associated with a given service involving the mobile terminal, with respect to routing the given service via one or both of the circuit switched subsystem and the IMS subsystem, based on predetermined decision information, as previously described.

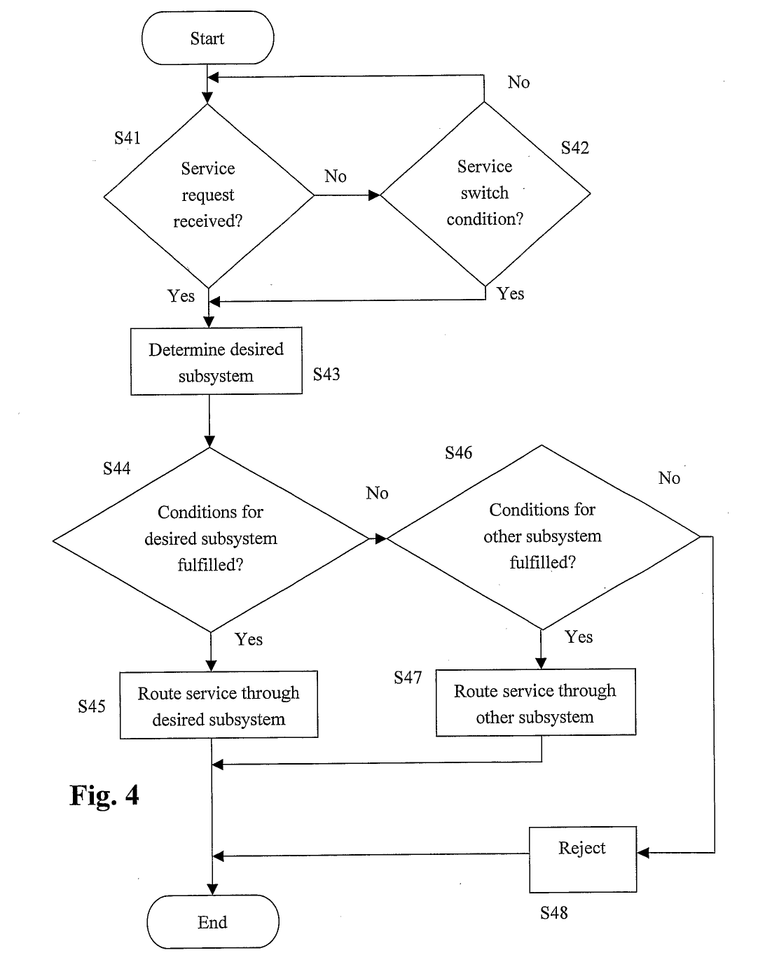

FIG. 4 shows a further method embodiment of the present invention. In a first step S41 it is determined whether a service request has been received. If not, it is determined whether a service switch condition is present. It may be noted that steps S41 and S42 are an example of the basic step S31 shown in FIG. 3, namely whether a service routing decision is to be made. In the example of FIG. 4, the service request of step S41 can e.g. be a request for a terminating service to the terminal, such as sending a call or message to the terminal, or it can be a request for originating a service, i.e. the terminal wanting to send a call or a message.

The service switch condition of step S42 relates to a situation when a service is already being provided, e.g. a call to the terminal is in progress, and a situation is reached where the switching of the service from the present subsystem to the other subsystem is considered-desirable, e.g. if the transmission conditions in the subsystem presently carrying the service deteriorate below a predetermined threshold.

If steps S41 or S42 indicate that a service routing decision is to be made, the flow proceeds to step S43, in which a desired subsystem is determined. The desired subsystem can be chosen in any suitable or desirable way, and will generally depend on one or more of the previously described types of decision information. For example, the procedure in step S42 can be such that if a service request for a certain type of service has been received (e.g. a request for a voice call), then S43 looks up a preference information, where it is e.g. laid down that the circuit switched subsystem is the preferred subsystem for voice calls. In such an example, step S43 would then select the circuit switched subsystem as the desired subsystem.

The flow then precedes to step S44, in which it is determined whether one or more predetermined first conditions associated with the desired subsystem and with predetermined decision information are fulfilled. For example, in keeping with the previous examples of a voice call preferably being routed through the circuit switched subsystem, step S44 could comprise checking whether the circuit switched subsystem is available and/or whether the mobile terminal is within the coverage of the circuit switched subsystem.

If the predetermined first conditions are fulfilled, then the method proceeds to step S45, in which it is decided to route the service through the desired subsystem, i.e. through the circuit switched subsystem in the above mentioned example. On the other hand, if step S44 indicates that the first conditions are not fulfilled, the method precedes to step S46, in which it is determined whether one or more predetermined second conditions associated with the other subsystem than the desired subsystem (the IMS subsystem in the above-mentioned example of a voice call and the circuit switched subsystem being preferred for voice calls) and the predetermined decision information are fulfilled. For example, the conditions and related decision information could be to check whether the IMS subsystem is available, whether the terminal is within the coverage area of the IM subsystem (these conditions and this information is the same as was checked in the example with respect to step S44), and in addition step S46 could e.g. check whether the terminal device is capable of receiving the voice call via the IMS subsystem (this is an example of an additional condition and information with respect to the conditions and information checked in step S44). Naturally, the indicated conditions and information items are only examples to illustrate the more general concept indicated in steps S44 and S46.

If the outcome of step S46 is such that the second conditions are fulfilled, then the method precedes to step S47, in which it is decided to route the given service through the other subsystem.

If the outcome of step S46 is negative, i.e. that the second conditions are also not fulfilled, then there are two basic possibilities for proceeding further. One, which is shown in the method of FIG. 4, consists in simply rejecting the routing of the given service. In this way, a hunting situation is avoided, i.e. a situation where the service routing decision entity and method would repeatedly attempt to route through the circuit switched subsystem and the IMS subsystem.

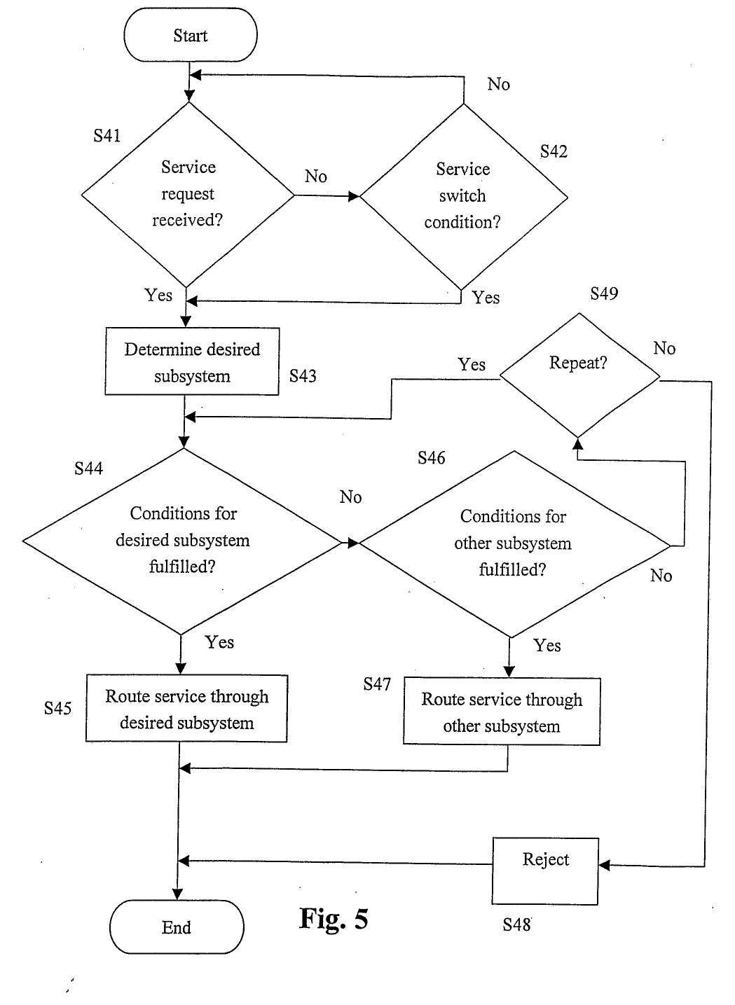

However, it may be desirable to allow a limited amount of hunting, which is shown in the example of FIG. 5. The example of FIG. 5 is identical to that of FIG. 4, except that if the outcome of step S46 is negative, then it is checked in S49 whether a repeat interruption condition is fulfilled, and if not, steps S44 and possibly S46 are repeated. If the repeat interruption condition is fulfilled, then the method proceeds to step S48, in which routing of the given service is rejected, similar to the immediate decision in FIG. 4. The repeat interruption condition could e.g. be fixed as a number of times for attempting to route through the two subsystems, or could be a time condition, i.e. where the routing attempts are repeated for a predetermined time period. In other words, the repeat interruption condition is reached if a certain number of repetitions has occurred, or if a certain amount of time has passed.

The example of FIG. 5 is related to the general concept of repeating the determining steps S44, S46 with respect to the predetermined first and second conditions until one of the first conditions are fulfilled, upon which it is decided to route the given service through the desired subsystem, or the second conditions are fulfilled, upon which it is decided to route the given service through the other subsystem than the desired subsystem, or a repeat-interruption condition is fulfilled, upon which routing the given service is rejected.

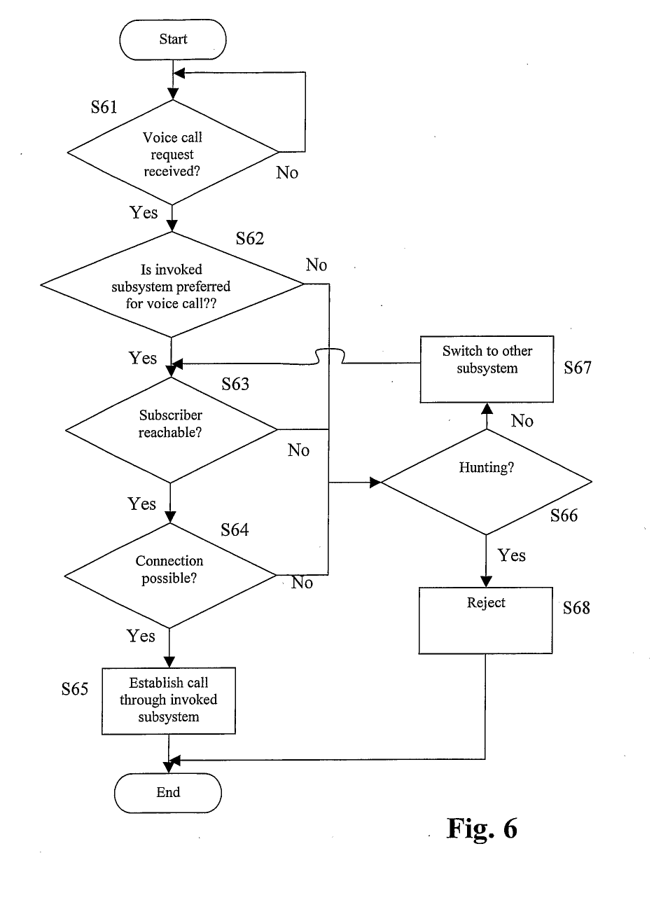

It is noted that the embodiments of FIGS. 4 and 5 are only examples, and that the concepts embodied therein can also be expressed in arrangements having a different sequence of steps. For example, FIG. 6 shows a method embodiment in which the procedure in the service routing decision entity for processing a request for a voice call is shown. In step S61 it is determined whether a voice call request has been received. If yes, step S62 determines whether the invoked subsystem (i.e. the subsystem requested in the voice call request) is preferred for a voice call. If the invoked system is preferred, then step S63 determines whether the subscriber is reachable (i.e. the decision information here is reachability information). If yes, step S64 determines whether a connection is possible (e.g. using availability information and/or capability information). If step S64 indicates that a connection is possible, then step S65 decides to establish the voice call through the invoked subsystem.

If on the other hand step S62 indicates that the invoked subsystem is not preferred, or step S63 indicates that the subscriber is not reachable in the invoked subsystem, or step S64 indicates that a connection is not possible in the invoked subsystem, then the method proceeds to step S66, in which it is determined whether a hunting case is present. This means it is determined whether the other subsystem than the invoked subsystem has already been checked for possibly establishing the voice call. If it has, then there is a hunting condition and step S66 passes to step S68, in which it is decided to reject routing the given service. On the other hand, if it is not a hunting case, then step S67 switches to the other subsystem as the invoked subsystem, and loops back to step S63, in which it is determined whether the subscriber is reachable via that subsystem, and if yes, step S64 determines whether a connection is possible through that subsystem. If yes, the call is established through the other subsystem, and if not, due to the hunting condition now being met, the routing of the service will be rejected. Therefore, comparing FIGS. 6 and 4, it can be seen that step S62 is an example for step S43, and that steps S63, S64 are an example for steps S44 or S46, because the first and second conditions described in connection with FIG. 4 are identical in the example of FIG. 6. Furthermore, step S65 is an example for steps S45 or S47.

The marking of a service as a hunting case can be achieved using a database, where possibly an already existing database can be used or a new dedicated database will be set up. Alternatively, one can mark a service by a hop counter. As another alternative, one can include a marker in the service request to state that it should not be looped back to the other subsystem if the desired subsystem cannot complete the service.

The service routing decision entity and method can be used for terminating and originating services. In the case of the terminal originating a service request, two basic cases are possible. The terminal can make a service request via the circuit switched subsystem, whereupon the circuit switched subsystem queries the service routing decision entity for a decision. If the service routing decision entity decides that the service switched subsystem is to be used, the service is set up via the circuit switched domain. If the service routing decision entity decides that the IMS subsystem is to be used, the service desired by the terminal is rejected with an indication that the IMS subsystem is to be used.

If the terminal makes a service request via the IMS subsystem, the IMS subsystem can query the service routing decision entity for a decision. If the service routing decision entity decides that the IMS subsystem is to be used, the service is set up via the IMS subsystem. If the service routing decision entity decides that the circuit switched subsystem is to be used, the service routing decision entity rejects the service set up with an indication that the circuit switched subsystem is to be used.

It is noted that the service routing decision entity can entirely or partially also be placed into the mobile terminal, for making decisions relating to service requests originating at the terminal.

A number of different arrangements could be used for embodying the service routing decision entity in the mobile terminal:
the subsystem selection could e.g. be based on a terminal setting, which could in turn be static, dynamic, based on terminal capability, etc.
the subsystem selection can be based on a preference set by the subscriber of the terminal, where the subscriber preference setting can be managed in the terminal.
the subsystem selection logic or network preferences can be sent from the network via over-the-air (OTA) activation procedures and stored in the terminal. Another mechanism for providing logic to the terminal can be by using the SIM toolkit or a configuration SMS.
the network's subsystem selection preferences can be sent from the network at the time of location update or registration.

As already mentioned previously, the service routing decision entity of the present invention can be located in one node or spread out over several nodes. For example, it can be a stand-alone application server (as indicated in dotted lines in FIG. 2) that is separate from the MSC 211 and the TAS 221. The advantage of such a solution is that it does not put any additional load on existing nodes, and that there is a central implementation, i.e. direct and central administration.

On the other hand, the service routing decision entity can also be embodied within the TAS 221 or within the MSC 211. This has the advantage that no new servers are needed and it optimises the routing for given access types. However, it causes additional load on existing nodes.

Furthermore, the service routing decision entity can be embodied as an internal function in a combined MSC/TAS, i.e. in a control node common to the circuit switched subsystem and the IMS subsystem. This has the advantage that no new external interfaces are needed and it can be a proprietary enhancement of such a combined MSC/TAS.

The service routing decision entity can also be embodied as a part of the HSS 229 or the HLR/VLR 214. This has advantages if the decision information is primarily related to subscriber data, because the subscriber data is held at the HSS or HLR. On the other hand, it has the disadvantage of creating a high load on the HSS or HLR.

Although the present invention has been described on the basis of preferred embodiments, these only serve to provide a better understanding of the invention and are not intended to be limiting. The scope of protection is defined by the appended claims. Reference signs and numerals in the claims have no limiting effect and only serve to make the claims easier to read.

1. A service routing decision entity for a system that comprises a circuit switched subsystem, an Internet Protocol Multimedia System subsystem and at least one mobile terminal suitable for communication with said circuit switched subsystem and said Internet Protocol Multimedia System subsystem, said circuit switched subsystem providing a first set of services and said Internet Protocol Multimedia System subsystem providing a second set of services, said first and second set of services being at least partially overlapping, said service routing decision entity comprising:
means for making a routing decision associated with a given service involving said at least one mobile terminal with respect to routing said given service via one or both of said circuit switched subsystem and said Internet Protocol Multimedia System subsystem, based on predetermined decision information.

2. The service routing decision entity of claim 1, wherein said decision information comprises one or more of
a reachability information associated with a reachability of said mobile terminal via one or both of said circuit switched subsystem and said Internet Protocol Multimedia System subsystem,
a preference information associated with a preference set by a user of said at least one mobile terminal,—a preference information associated with a preference set by an operator of said circuit switched subsystem,
a preference information associated with a preference set by an operator of said Internet Protocol Multimedia System subsystem,—a subscription information associated with a subscription of said user of said at least one mobile terminal,
a time information associated with a time of day.
a load information associated with a load of one or both of said circuit switched subsystem and said Internet Protocol Multimedia System subsystem,—a coverage information associated with a coverage of one or both of said circuit switched subsystem and said Internet Protocol Multimedia System subsystem.
an availability information associated with an availability of one or both of said circuit switched subsystem and said Internet Protocol Multimedia System subsystem,
a service type information associated with a service type of said given service involving said at least one mobile terminal.—a service use information associated with one or more services actively being provided to said at least one mobile terminal,
a connection information associated with one or more active connections involving one or more of said circuit switched subsystem, said Internet Protocol Multimedia
System subsystem and said mobile terminal comprising one or more of,
a terminal capability information associated with a capability of said mobile terminal,
a circuit switched subsystem node capability information associated with a capability of a node of said circuit switched subsystem, and
an Internet Protocol Multimedia System subsystem node capability information associated with a capability of a node of said Internet Protocol Multimedia System subsystem.

3. The service routing decision entity of claim 1, comprising a first part in the circuit switched subsystem and a second part in the Internet Protocol Multimedia System subsystem.

4. The service routing decision entity of claim 3, where said first part is adapted for sending reachability information associated with a reachability of said at least one mobile terminal in said circuit switched subsystem to said second part, and said second part is adapted for making a routing decision.

5. The service routing decision entity of claim 3, where said second part is adapted for sending reachability information associated with a reachability of said at least one mobile terminal in said Internet Protocol Multimedia System subsystem to said first part, and said first part is arranged for making a routing decision.

6. The service routing decision entity of claim 1, wherein said service routing entity is contained in a dedicated application server.

7. The service routing decision entity of claim 1, wherein said circuit switched subsystem has a routing control node (MSC), and said service routing entity is contained in said circuit switched routing control node.

8. The service routing decision entity of claim 1, wherein said Internet Protocol Multimedia System subsystem has a routing control node, and said service routing entity is contained in said Internet Protocol Multimedia System routing control node.

9. The service routing decision entity of claim 1, wherein said service routing entity is contained in a network node that acts as a routing control node for said circuit switched subsystem and said Internet Protocol Multimedia System subsystem.

10. The service routing decision entity of claim 1, wherein at least a part of said service routing entity is contained in said at least one mobile terminal.

11. A service routing decision method for a system that comprises a circuit switched subsystem, an Internet Protocol Multimedia System subsystem and at least one mobile terminal suitable for communication with said circuit switched subsystem and said Internet Protocol Multimedia System subsystem, said circuit switched subsystem providing a first set of services and said Internet Protocol Multimedia System subsystem providing a second set of services, said first and second set of services being at least partially overlapping, said service routing decision method comprising:
making a service routing decision associated with a given service involving said at least one mobile terminal with respect to routing said given service via one or both of said circuit switched subsystem and said Internet Protocol Multimedia System subsystem, based on predetermined decision information.

12. The service routing decision method of claim 11, wherein said decision information comprises one or more of
a reachability information associated with a reachability of said mobile terminal via one or both of said circuit switched subsystem and said Internet Protocol Multimedia System subsystem,—a preference information associated with a preference set by a user of said at least one mobile terminal,
a preference information associated with a preference set by an operator of said circuit switched subsystem,
a preference information associated with a preference set by an operator of said Internet Protocol Multimedia
System subsystem.
a subscription information associated with a subscription of said user of said at least one mobile terminal,
a time information associated with a time of day,—a load information associated with a load of one or both of said circuit switched subsystem and said Internet Protocol Multimedia System subsystem,
a coverage information associated with a coverage of one or both of said circuit switched subsystem and said Internet Protocol Multimedia System subsystem,
an availability information associated with an availability of one or both of said circuit switched subsystem and said Internet Protocol Multimedia System subsystem,—a service type information associated with a service type of said given service involving said at least one mobile terminal,
a service use information associated with one or more services actively being provided to said at least one mobile terminal,
a connection information associated with one or more active connections involving one or more of said circuit switched subsystem, said Internet Protocol Multimedia System subsystem and said mobile terminal,—a terminal capability information associated with a capability of said mobile terminal,
a circuit switched subsystem node capability information associated with a capability of a node of said circuit switched subsystem, and—an Internet Protocol Multimedia System subsystem node capability information associated with a capability of a node of said Internet Protocol Multimedia System subsystem.

13. The service routing decision method of claim 11, comprising the steps of:
determining one of said circuit switched subsystem and said Internet Protocol Multimedia System subsystem as a desired subsystem for said given service,
determining whether one or more predetermined first conditions associated with said desired subsystem and said predetermined decision information are fulfilled,
deciding to route said given service through said desired subsystem if said one or more predetermined first conditions are fulfilled,
if said one or more predetermined first conditions are not fulfilled, determining whether one or more predetermined second conditions associated with the other than said desired subsystem and said predetermined decision information are fulfilled, and
deciding to route said given service through said other than said desired subsystem if said one or more predetermined second conditions are fulfilled.

14. The service routing decision method of claim 13, comprising: rejecting routing said given service if said one or more predetermined second conditions are not fulfilled.

15. The service routing decision method of claim 13, comprising: repeating said determining steps with respect to said predetermined first and second conditions until one of
said first conditions are fulfilled, upon which it is decided to route said given service through said desired subsystem,
said second conditions are fulfilled, upon which it is decided to route said given service through said other subsystem than said desired subsystem, and
a repeat interruption condition is fulfilled, upon which routing said given service is rejected.
